(19) United States
(12) Patent Application Publication
(10) Pub. No.: US 2016/0232840 A1
(43) Pub. Date: Aug. 11, 2016

(54) OLED DISPLAY PANEL WITH THRESHOLD VOLTAGE COMPENSATION AND DRIVING METHOD THEREOF

(71) Applicant: InnoLux Corporation, Miao-Li County (TW)

(72) Inventors: Ming-Chun TSENG, Miao-Li County (TW); Kung-Chen KUO, Miao-Li County (TW)

(21) Appl. No.: 14/987,926

(22) Filed: Jan. 5, 2016

(30) Foreign Application Priority Data
Feb. 5, 2015 (CN) 201510059887.6

(51) Int. Cl. G09G 3/32; G09G 5/10

(52) U.S. Cl. CPC G09G 3/3225; G09G 5/10; G09G 2300/0852; G09G 2320/0233; G09G 2300/043

(57) ABSTRACT

In an OLED display panel with threshold voltage compensation, a data programming transistor has a first control end for receiving a first control signal, a first end connected to a data line, and a second end. A driving transistor has a second control end, a third end, and a fourth end. A storage capacitor is connected to the second end and the second control end. A compensating transistor has a third control end for receiving a second control signal, a fifth end connected to the storage capacitor, and a sixth end connected to the fourth end. A compensating capacitor is connected to the third end, the fifth end, and the second control end. A turn-on transistor has a fourth control end for receiving a third control signal, a seventh end connected to the fourth end, and an eighth end connected to an OLED device.

### BACKGROUND OF THE INVENTION

1. Field of the Invention

The present invention relates to the technical field of liquid crystal display (LCD) devices and, more particularly, to an organic light emitting diode (OLED) display panel with threshold voltage compensation and driving method thereof.

2. Description of Related Art

Driving transistors for active matrix organic light emitting diode (AMOLED) pixels are classified into P-type driving and N-type driving based on the backplane technology. Typically, the P-type driving is applied in the LTPS backplane technology the N-type driving is applied in the a-Si and IGZO backplane technology. FIGS. 1 and 2 illustrate the 2T1C (two transistors one capacitor) pixel circuit having a P-type driving transistor in cooperation with a normal OLED device and the 2T1C pixel circuit having an N-type driving transistor in cooperation with an inverted OLED device, respectively, in the prior art.

The P-type driving transistor PTFT_dri has a gate/source voltage Vgs that corresponds to a data voltage and a high voltage ELVDD, wherein the high voltage ELVDD has a constant relative high voltage value. The N-type driving transistor NTFT_dri has a gate/source voltage Vgs that corresponds to a data voltage and a low voltage ELVSS, wherein the high voltage ELVDD and the low voltage ELVSS have a constant relative high voltage value and a constant relative low voltage value, respectively, which are not changed with time. For the known P-type driving transistor PTFT_dri, it encounters the phenomenon of threshold voltage deviation. That is, due to the polycrystalline process, the threshold voltage Vt of an LTPS P-type driving transistor is likely to generate a local variance. Accordingly, when driving voltages of the same value are inputted to two P-type driving transistors of the same size, respectively, they cannot output currents of the same value, resulting in the mura or poor brightness uniformity problem.

FIG. 3 is a prior 6T1C pixel circuit with a P-type driving transistor. FIG. 4 is a voltage compensation timing diagram for the threshold voltage Vt of the 6T1C P-type driving transistor shown in FIG. 3. Because the 6T1C driving circuit has too many devices including six transistors T1-T6 and one capacitor Cst, the pixel layout is limited and thus the existent manufacturing process is unable to achieve the high definition (>300 ppi) requirement. Furthermore, because the compensating time is equal to the writing time per data, the compensating effect may be poor due to relatively short compensating time (<10 us) in a high resolution (such as FHD_1080RGB*1920, QHD_1440RGB*2560) application. Therefore, it is desired for the prior pixel circuit to be improved for mitigating and/or obviating the aforementioned problems.

### SUMMARY OF THE INVENTION

The object of the present invention is to provide an organic light emitting diode (OLED) display panel with threshold voltage compensation and driving method thereof, which can be applied in high PPI (pixel per inch) products for allowing the compensating time of a compensating period to be greater than the gate line time, and which can avoid the dark leakage and IR drop of an OLED device and compensate for the IR drop of the high voltage ELVDD.

According to one aspect of the present invention, there is provided an OLED display panel with threshold voltage compensation having a plurality of pixel circuits. Each pixel circuit comprises a data programming transistor, a storage capacitor, a driving transistor, a compensating transistor, a compensating capacitor, and a turn-on transistor. The data programming transistor includes a first control end connected to a first control signal, a first end connected to a data line, and a second end. The driving transistor includes a second control end, a third end, and a fourth end. The storage capacitor is connected to the second end and the second control end. The compensating transistor includes a third control end connected to a second control signal, a fifth end connected to the storage capacitor, and a sixth end connected to the fourth end. The compensating capacitor is connected to the third end, the fifth end, and the second control end. The turn-on transistor includes a fourth control end connected to a third control signal, a seventh end connected to the fourth end, and an eighth end connected to an OLED device.

According to another aspect of the present invention, there is provided a method of driving an OLED display panel with threshold voltage compensation. The display panel has a plurality of pixel circuits arranged in rows and columns for forming a plurality of bands, each band having N rows of pixels, where N is a positive integer. The method comprises using N first control signals, a second control signal, and a third control signal to control each band, the N first control signals, the second control signal, the third control signal respectively providing corresponding control signals sequentially, so as to allow each band to have a reset period, a compensating period, a programming period, and an emitting period, wherein the reset period, the compensating period, the programming period, and the emitting period are independently operated, and the compensating period has a compensating time greater than a gate line time.

Other objects, advantages, and novel features of the invention will become more apparent from the following detailed description when taken in conjunction with the accompanying drawings.

### BRIEF DESCRIPTION OF THE DRAWINGS

FIG. 1 is a prior 2T1C pixel circuit with a P-type driving transistor;

FIG. 2 is a prior 2T1C pixel circuit with an N-type driving transistor;

FIG. 3 is a prior 6T1C pixel circuit with a P-type driving transistor;

FIG. 4 is a voltage compensation timing chart for a threshold voltage of the 6T1C P-type driving transistor shown in FIG. 3.

FIG. 5 is a schematic diagram of an OLED display panel with threshold voltage compensation according to the invention;

FIG. 6 is a circuit diagram of a pixel circuit with threshold voltage compensation according to an embodiment of the invention;

FIG. 7 is a timing diagram for a pixel circuit with threshold voltage compensation according to the invention;

FIG. 8 schematically illustrates the states of each transistor in FIG. 6 according to the invention;

FIG. 9 schematically illustrates the voltages of each node in FIG. 6 according to the invention;

FIG. 10 is a circuit diagram of a pixel circuit with threshold voltage compensation according to another embodiment of the invention;

FIG. 11 is a circuit diagram of a pixel circuit with threshold voltage compensation according to a further embodiment of the invention;

FIG. 12 schematically illustrates the operation of an OLED display panel with threshold voltage compensation according to the invention; and

FIG. 13 is a timing diagram for a method of driving an OLED display panel with threshold voltage compensation according to the invention.

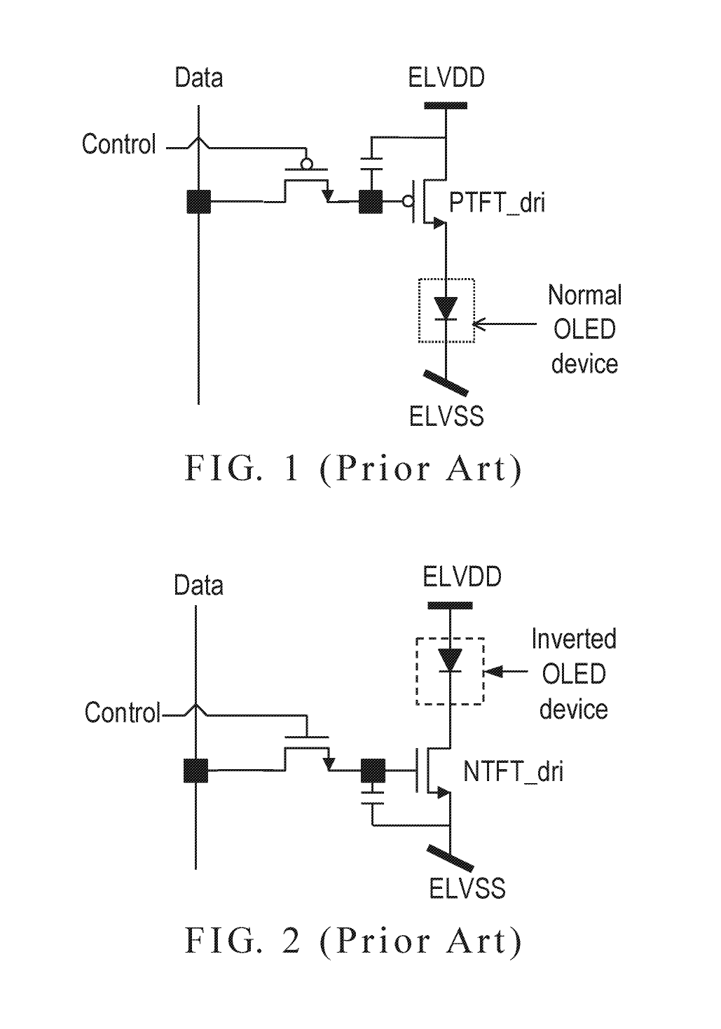

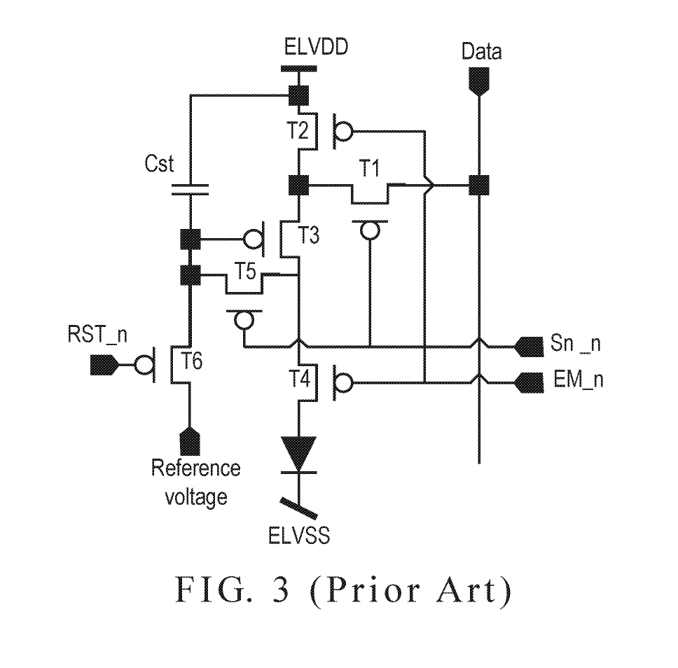

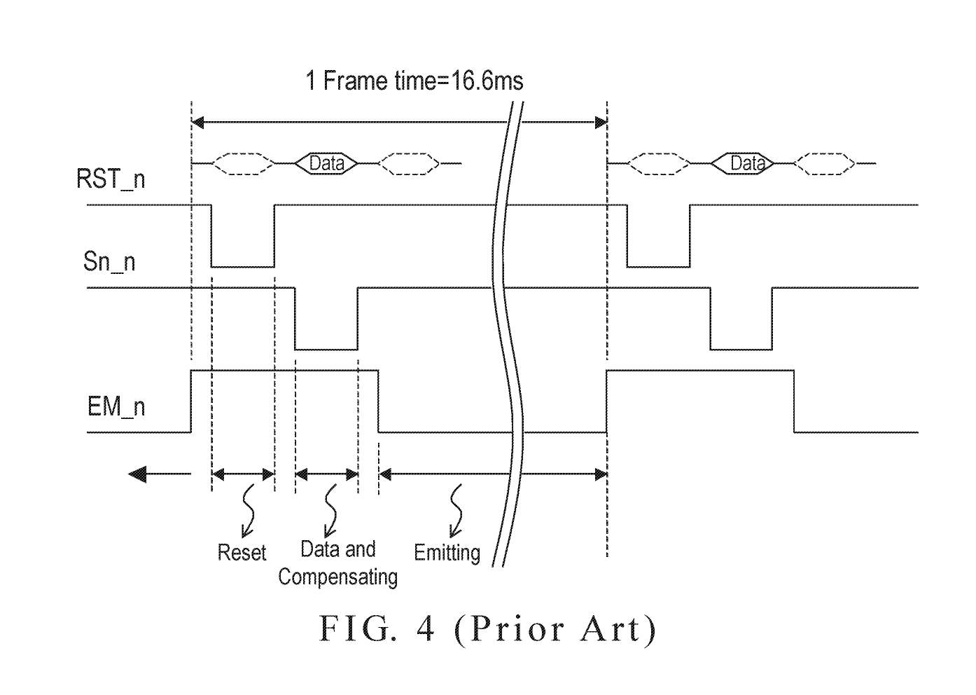

### DETAILED DESCRIPTION OF THE PREFERRED EMBODIMENT

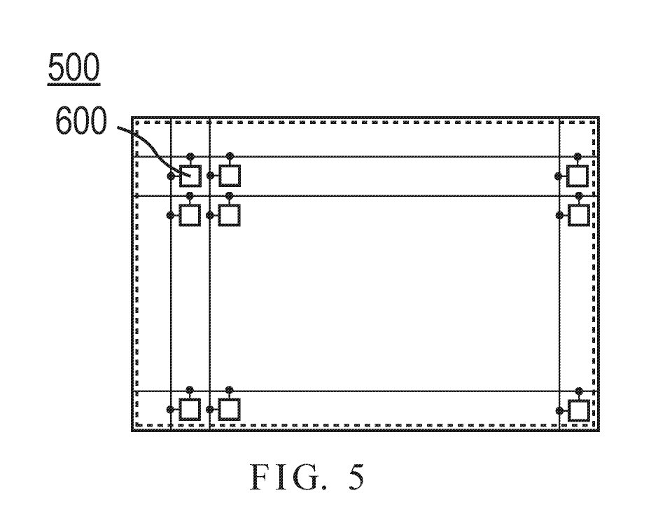

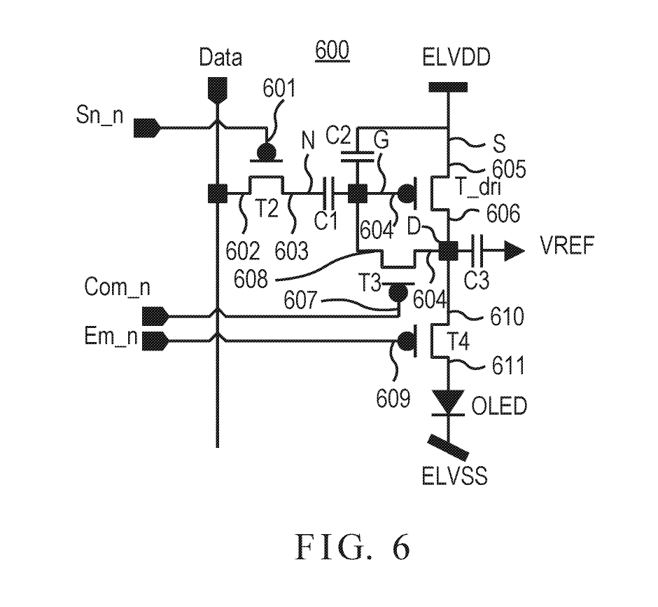

FIG. 5 is a schematic diagram of an organic light emitting diode (OLED) display panel with threshold voltage compensation according to the invention. The OLED display panel 500 has a plurality of pixel circuits 600 with threshold voltage compensation. Each of the pixel circuits 600 is provided to drive a respective OLED device for display. As shown in FIG. 6, there is shown a circuit diagram for one of the pixel circuits 600. The pixel circuit 600 with threshold voltage compensation includes a data programming transistor T2, a storage capacitor C1, a driving transistor T_dri, a compensating transistor T3, a compensating capacitor C2, and a turn-on transistor T4.

The data programming transistor T2 includes a first control end 601 connected to a first control signal SN_n, a first end 602 connected to a data line Data, and a second end 603. The driving transistor T_dri includes a second control end 604, a third end 605, and a fourth end 606. The storage capacitor C1 is connected to the second end 603 and the second control end 604. The compensating transistor T3 includes a third control end 607 connected to a second control signal Com_n, a fifth end 608 connected to the storage capacitor, and a sixth end 609 connected to the fourth end 606. The compensating capacitor C2 is connected to the third end 605, the fifth end 608, and the second control end 604. The turn-on transistor T4 includes a fourth control end 609 connected to a third control signal Em_n, a seventh end 610 connected to the fourth end 606, and an eighth end 611 connected to an organic light emitting diode device OLED.

The data programming transistor T2 is provided to write a display data or a reset data Vrst. The storage capacitor C1 is coupled to the data programming transistor T2 for temporarily storing the display data or the reset data Vrst. The driving transistor T_dri is coupled to the storage capacitor C1 for generating a uniform driving current. The compensating transistor T3 is coupled to the driving transistor T_dri for compensating the threshold voltage Vth of the driving transistor T_dri. The compensating capacitor C2 is coupled to the driving transistor T_dri for temporarily storing the threshold voltage Vth of the driving transistor T_dri. The turn-on transistor T4 is coupled to the driving transistor T_dri and an organic light emitting diode device OLED for allowing the driving current of the driving transistor T_dri to pass therethrough so as to drive the organic light emitting diode device OLED. The compensating transistor T3 detects the threshold voltage Vth of the driving transistor T_dri and stores the same in the storage capacitor C1 or the compensating capacitor C2.

As shown in FIG. 6, the data programming transistor T2 has a gate connected to a first control signal SN_n, a source connected to a data line Data, and a drain connected to a first node N. The storage capacitor C1 has one end connected to the first node N and the other end connected to a second node G. The driving transistor T_dri has a gate connected to the second node G, a source connected to a third node S and further connected to a high voltage ELVDD, a drain connected to a fourth node D. The compensating transistor T3 has a gate connected to a second control signal Com_n, a source (or drain) connected to the second node G, and a drain (or source) connected to the fourth node D. The compensating capacitor C2 has one end connected to the second node G and the other end connected to the third node S. The turn-on transistor T4 has a gate connected to a third control signal Em_n, a source connected to the fourth node D, and a drain connected to one end of the organic light emitting diode device OLED. The organic light emitting diode device OLED has the other end connected to a low voltage ELVSS.

The pixel circuit 600 with threshold voltage compensation further includes a reference voltage capacitor C3. The reference voltage capacitor C3 has one end connected to the fourth node D and the other end connected to a reference voltage VREF. The voltage VREF can be a DC bias such as the voltage ELVDD, or the voltage ELVSS.

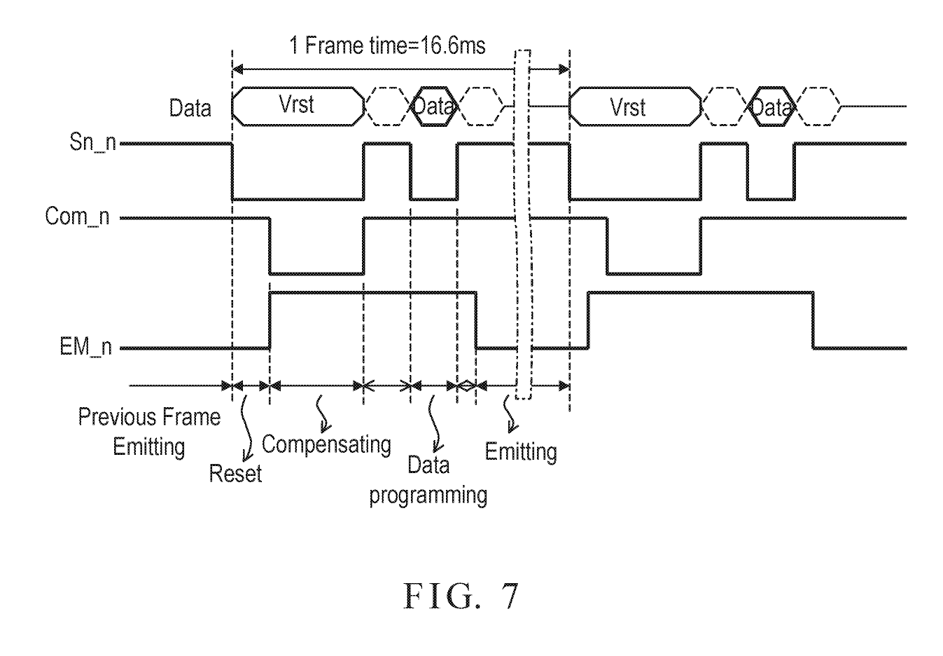

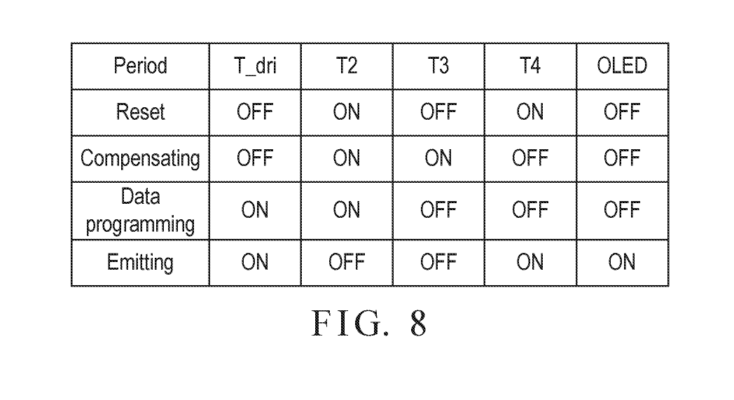

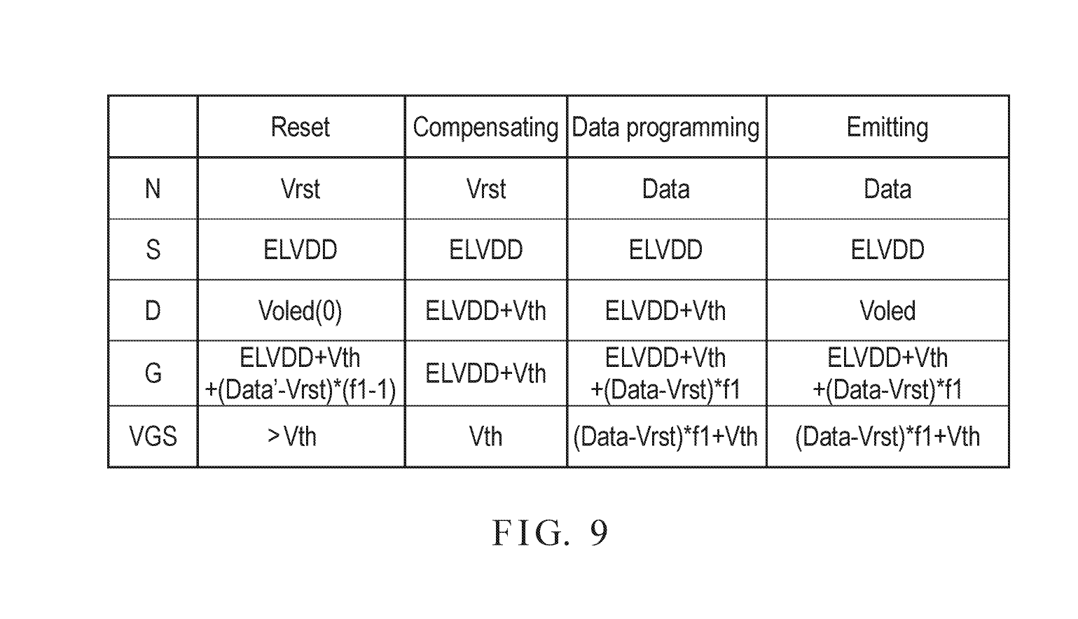

FIG. 7 is a timing diagram for the pixel circuit 600 with threshold voltage compensation according to the invention. FIG. 8 shows the states of each transistor in FIG. 6 according to the invention. FIG. 9 shows the voltages of each node in FIG. 6 according to the invention.

With reference to FIGS. 6-9, in a reset period, the first control signal SN_n is a low control voltage (VSS), the second control signal Com_n is a high control voltage (VDD), and the third control signal Em_n is a low control voltage (VSS). The voltage level of the high control voltage (VDD) can be equal to or different from that of the high voltage ELVDD. Similarly, the voltage level of the low control voltage (VS S) can be equal to or different from that of the low voltage ELVSS.

In the reset period, the data programming transistor T2 and the turn-on transistor T4 are turned on, the driving transistor T_dri and the compensating transistor T3 are turned off, and there is a reset data (Vrst) on the data line, so as to reset the node N to have a voltage Vrst. Furthermore, the voltage Vrst is coupled to the node G through the storage capacitor C1. The gate G of the driving transistor T_dri has a voltage expressed as:

VG=ELVDD+Vth+(Data′−Vrst)*(f1−1), (1)

where f1=C1/(C1+C2+C_paras), i.e., f1<1, C_paras represents a parasitic capacitance of the gate of the driving transistor T_dri, Data′ represents a display data of a previous frame period, Vrst represents the reset data ELVDD written in the reset period which is a value of the high voltage ELVDD, and Data′ is smaller than Vrst. Thus, the gate (or the node G) of the driving transistor T_dri has a voltage greater than ELVDD+Vth, which is high enough to make the driving transistor T_dri in an off state (OFF). In addition, the voltage of the node D is reset to Voled(0) because of the turn-on transistor T4 being turned on, where Voled(0) represents the threshold voltage of the organic light emitting diode device OLED. The node S is provided with the voltage ELVDD. In the reset period, there is no current path existed in the organic light emitting diode device OLED so as to prevent the organic light emitting diode device OLED from dark leakage and IR drop.

In a compensating period, the first control signal SN_n is a low control voltage (VSS), the second control signal Com_n is a low control voltage (VS S), and the third control signal Em_n is a high control voltage (VDD). The data programming transistor T2 and the compensating transistor T3 are turned on and the driving transistor T_dri and the turn-on transistor T4 are turned off. Since the compensating transistor T3 is turned on, the reference voltage capacitor C3 performs charge charging with the storage capacitor C1 and the compensating capacitor C2. Namely, the gate and drain of the driving transistor T_dri perform a charge sharing through the compensating transistor T3. At this moment, the driving transistor becomes a diode connection and thus is in an on state (ON). Then, the gate of the driving transistor T_dri is slowly discharged to ELVDD+Vth, thereby completing detection of the threshold voltage of the driving transistor T_dri and storing the detected threshold voltage in the storage capacitor C1 and the compensating capacitor C2. Because the gate of the driving transistor T_dri is discharged to ELVDD+Vth, the driving transistor T_dri is turned on only in the beginning of the compensating period, while being turned off in most of the compensating period. The reference voltage capacitor C3 cited above can be a parasitic capacitance; i.e., the reference voltage capacitor C3 is not a physical capacitor.

In a programming period, the first control signal SN_n is a low control voltage (VSS), the second control signal Com_n is a high control voltage (VDD), and the third control signal Em_n is a high control voltage (VDD). The data programming transistor T2 and the driving transistor T_dri are turned on and the compensating transistor T3 and the turn-on transistor T4 are turned off. Since the data programming transistor T2 is turned on, the display data is written and stored in the storage capacitor C1. The data programming transistor T2 is turned on so as to write a display data Data in the node N, and the display data Data is further coupled by the storage capacitor C1 to the node G Therefore, the voltage of the node G is expressed as:

VG=ELVDD+Vth+(Data−Vrst)*f1, (2)

where Data represent a display data of a current frame. In this programming period, the driving transistor T_dri is required to be in an on state, i.e., VG<ELVDD+Vth. Thus, from the equation (2), the following relation can be obtained:

Data≦Vrst. (3)

In an emitting period, the first control signal SN_n is a high control voltage (VDD), the second control signal Com_n is a high control voltage (VDD), and the third control signal Em_n is a low control voltage (VS S). The driving transistor T_dri and the turn-on transistor T4 are turned on and the data programming transistor T2 and the compensating transistor T3 are turned off. The current of the driving transistor T_dri is expressed as:

I_{—T}_{_}_{dri}=I_{—OLED}=Kp*(Vgs−Vth)²=Kpn*[{Data−Vrst}*f1]², (4)

where Vrst represents the reset data written in the reset period, Data represents the display data written in the programming period, Kpn represents a transistor transconductance parameter of the driving transistor T_dri, Kpn=½ uCox*W/L, u represents a carrier mobility, Cox represents a capacitance per unit area, and W/L represents a ratio of width to length.

As cited above, the pixel circuit 600 with threshold voltage compensation of the invention is a 4T2C (four transistors two capacitors) driving circuit, and the compensating period and the programming period are independently operated. Therefore, the compensating time can be increased or decreased by adjusting the time width and related signal positions of the compensating period, without being limited to one scan line time. That is, a compensating time of the compensating period is greater than a gate line time. Thus, the invention can be applied to a large-size and high resolution panel.

In addition, because there is no high voltage ELVDD in equation (4), the invention is also provided with the function of compensating for the IR drop of the voltage ELVDD.

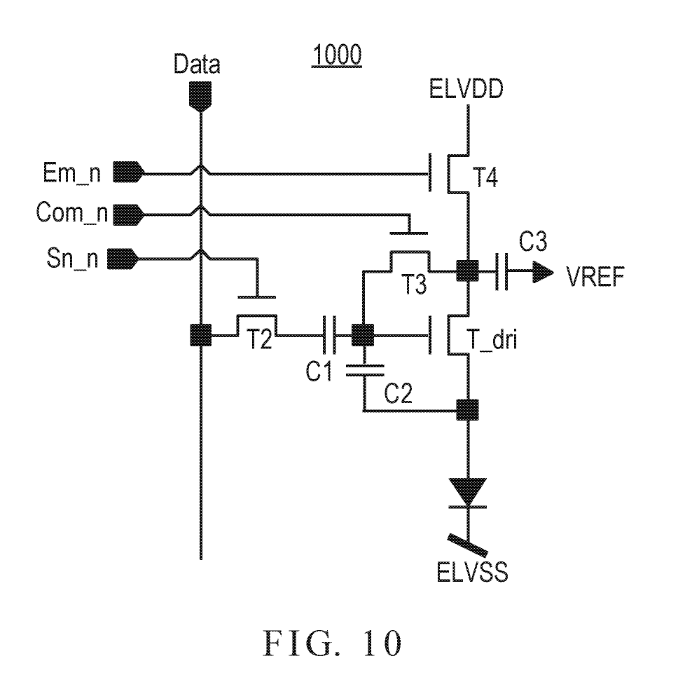

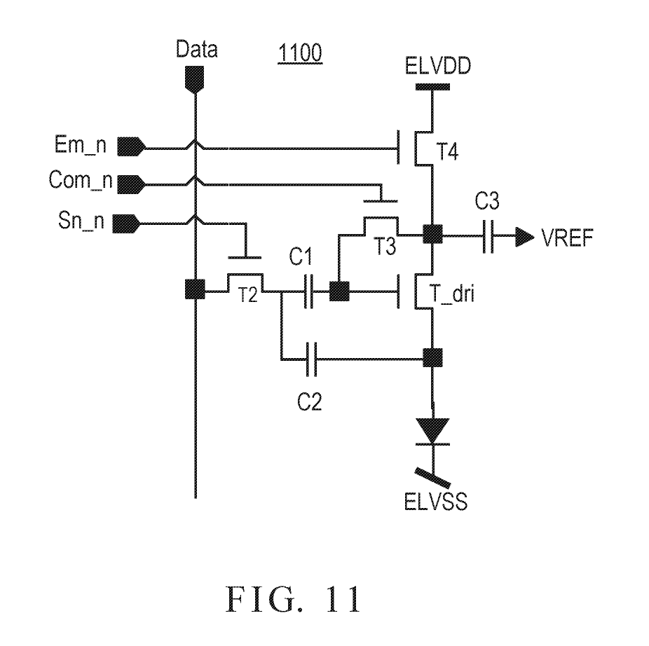

FIG. 10 is a circuit diagram of a pixel circuit 1000 with threshold voltage compensation according to another embodiment of the invention, which is a dual type circuit with respect to that of FIG. 6. FIG. 11 is a circuit diagram of a pixel circuit 1100 with threshold voltage compensation according to a further embodiment of the invention, which is similar to the circuit of FIG. 10 except that one end of the compensating capacitor C2 in FIG. 11 is connected to the source/drain of the data programming transistor T2, but not the gate electrode of the driving transistor T_dri in FIG. 10. The operating principle of FIGS. 10 and 11 is the same as that of FIG. 6, and thus a detailed description is deemed unnecessary.

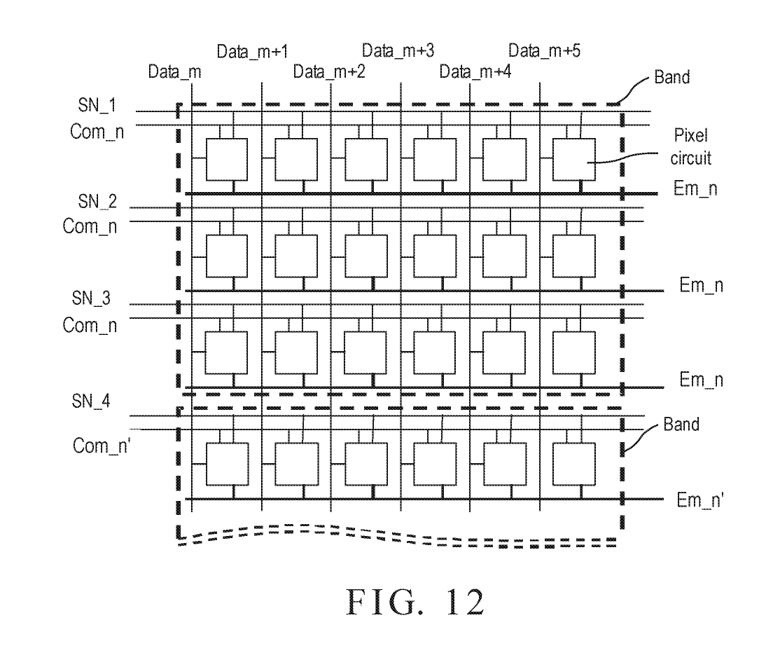

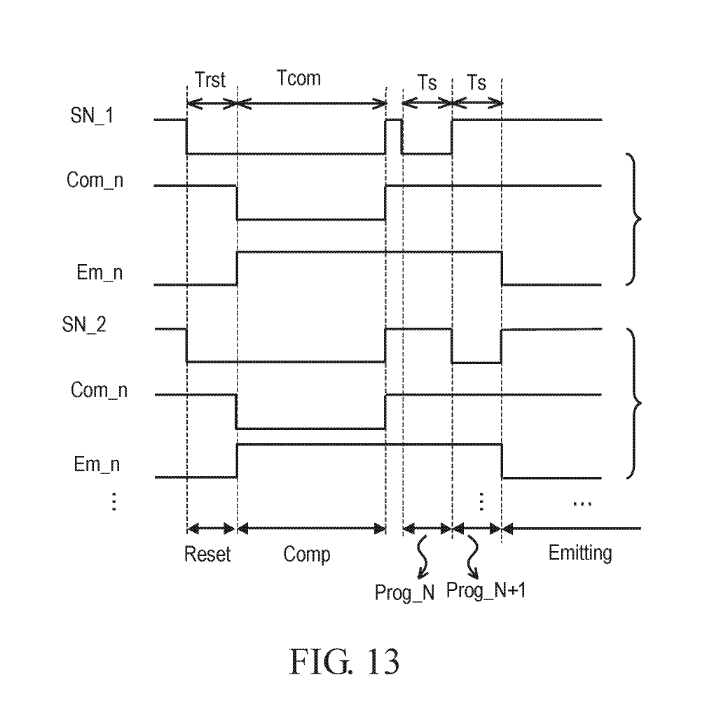

FIG. 12 schematically illustrates the operation of an OLED display panel with threshold voltage compensation according to the invention. FIG. 13 is a timing diagram for a method of driving an OLED display panel with threshold voltage compensation according to the invention. As shown in FIG. 12, the plurality of pixel circuits are arranged in rows and columns to form a plurality of bands, each band having N rows of pixel circuits (N is a positive integer), wherein the display panel has data lines Data_m, Data_m+1, . . . , etc. In the method, N first control signals SN_n, a second control signal Com_n, and a third control signal Em_n are used to control each band. The N first control signals SN_n, the second control signal Com_n, and the third control signal Em_n respectively provide corresponding control signals sequentially, so as to allow each band to have a reset period Reset, a compensating period Comp, a plurality of programming periods Prog, and an emitting period Emitting. In this embodiment, N is equal to 3. The reset period Reset occupies a period of time Trst. The compensating period Comp occupies a period of time Tcom. Each of the programming periods occupies a period of time Ts.

As shown in FIG. 13, the reset period Reset, the compensating period Comp, the programming periods Prog_N, Prog_N+1, . . . , and the emitting period Emitting are independently operated. The bands in the programming periods Prog are sequentially scanned. Since the compensating period Comp and the programming periods (Prog_N, Prog_N+1, . . . are independently operated, the compensating period Comp has a compensating time greater than a gate line time.

As cited above, the invention provides a 4T2C driving circuit, which has a smaller layout area, in comparison with the 6T1C driving circuit, and can be applied in high PPI (pixel per inch) products. In addition, the compensating period and the programming period are independently operated, so that the compensating period has a compensating time greater than a gate line time. Therefore, the invention can be applied to a large-size and high-resolution panel. Also, the invention can avoid the dark leakage and IR drop of the OLED and compensate for the IR drop of the voltage ELVDD.

Although the present invention has been explained in relation to its preferred embodiment, it is to be understood that many other possible modifications and variations can be made without departing from the spirit and scope of the invention as hereinafter claimed.

What is claimed is:

1. An OLED display panel with threshold voltage compensation having a plurality of pixel circuits, each pixel circuit comprising:
a data programming transistor having a first control end connected to a first control signal, a first end connected to a data line, and a second end;
a driving transistor having a second control end, a third end, and a fourth end;
a storage capacitor connected to the second end and the second control end;
a compensating transistor having a third control end connected to a second control signal, a fifth end connected to the storage capacitor, and a sixth end connected to the fourth end;
a compensating capacitor connected to the third end, the fifth end, and the second control end; and
a turn-on transistor having a fourth control end connected to a third control signal, a seventh end connected to the fourth end, and an eighth end connected to an OLED device.

2. The OLED display panel with threshold voltage compensation as claimed in claim 1, wherein, in an emitting period, the driving transistor has a driving current independent of a threshold voltage of the driving transistor.

3. The OLED display panel with threshold voltage compensation as claimed in claim 2, wherein the data programming transistor includes a gate for receiving the first control signal, a source connected to the data line, and a drain connected to a first node; the storage capacitor includes one end connected to the first node and the other end connected to a second node; the driving transistor includes a gate connected to the second node, a source connected to a third node and further connected to a high voltage, a drain connected to a fourth node; the compensating transistor includes a gate connected to the second control signal, and a source and a drain respectively connected to the second node and the fourth node or respectively connected to the fourth node and the second node; the compensating capacitor includes one end connected to the second node and the other end connected to the third node; the turn-on transistor includes a gate connected to the third control signal, a source connected to the fourth node and a drain connected to the OLED device.

4. The OLED display panel with threshold voltage compensation as claimed in claim 2, wherein, in a reset period, the data programming transistor and the turn-on transistor are turned on while the driving transistor and the compensating transistor are turned off, and the driving transistor has a gate voltage expressed as:
VG=ELVDD+Vth+(Data′−Vrst)*(f1−1),
where f1=C1/(C1+C2+C_paras), C_paras represents a parasitic capacitance of the gate of the driving transistor, Data′ represents display data of a previous frame period, and Vrst represents reset data written in the reset period.

5. The OLED display panel with threshold voltage compensation as claimed in claim 4, wherein, in a compensating period, the data programming transistor and the compensating transistor are turned on while the driving transistor and the turn-on transistor are turned off, so that, since the compensating transistor is turned on, the gate and the drain of the driving transistor perform a charge sharing through the compensating transistor, and the driving transistor becomes a diode connection to complete detection of the threshold voltage of the driving transistor and store the detected threshold voltage in the storage capacitor and the compensating capacitor.

6. The OLED display panel with threshold voltage compensation as claimed in claim 5, wherein, in a programming period, the data programming transistor and the driving transistor are turned on while the compensating transistor and the turn-on transistor are turned off, so that, since the data programming transistor is turned on, the display data is written and stored in the storage capacitor.

7. The OLED display panel with threshold voltage compensation as claimed in claim 6, wherein the compensating period and the programming period are independently operated, and a compensating time of the compensating period is greater than a gate line time.

8. The OLED display panel with threshold voltage compensation as claimed in claim 7, wherein, in the emitting period, the driving transistor and the turn-on transistor are turned on while the data programming transistor and the compensating transistor are turned off, and the driving transistor has a current expressed as:
I_{—T}_{_}_{dri}=I_{—OLED}=Kp*(Vgs−Vth)²=Kpn*[{Data−Vrst}*f1]²,
where Vrst represents the reset data written in the reset period, Data represents the display data written in the programming period, Kₚₙ represents a transistor transconductance parameter of the driving transistor, Kₚₙ=½ uCox*W/L, u represents a carrier mobility, Cox represents a capacitance per unit area, and W/L represents a ratio of width to length.

9. A method of driving an OLED display panel with threshold voltage compensation, the OLED display panel having a plurality of pixel circuits arranged in rows and columns for forming a plurality of bands, each band having N rows of pixels, where N is a positive integer, the method comprising: using N first control signals, a second control signal, and a third control signal to control each band, the N first control signals, the second control signal, and the third control signal respectively providing corresponding control signals sequentially, so as to allow each band to have a reset period, a compensating period, a programming period, and an emitting period,
wherein the reset period, the compensating period, the programming period, and the emitting period are independently operated, and the compensating period has a compensating time greater than a gate line time.

10. The method of driving an OLED display panel with threshold voltage compensation as claimed in claim 9, wherein the bands are sequentially scanned in the programming period.
